(19) United States
(12) Patent Application Publication
(10) Pub. No.: US 2026/0207427 A1
(43) Pub. Date: Jul. 23, 2026

(54) VALVE FOR RECONFIGURABLE WATER DISTRIBUTION SYSTEM FOR A WALK-IN TUB BATHING INSTALLATION

(71) Applicant: Daniel Oliver, Linden, TN (US)

(72) Inventor: Daniel Oliver, Linden, TN (US)

(21) Appl. No.: 19/448,039

(22) Filed: Jan. 13, 2026

Related U.S. Application Data
(60) Provisional application No. 63/747,327, filed on Jan. 20, 2025.
(60) Provisional application No. 63/822,589, filed on Jun. 12, 2025.

(51) Int. Cl. A61H 33/00; A47K 3/00; A47K 3/022; F16K 11/087; F16K 31/04

(52) U.S. Cl. CPC A61H 33/0087; A47K 3/022; A47K 3/006; F16K 11/0873; F16K 31/041

(57) ABSTRACT

A water distribution system for providing multiple bathing functions independently for a walk-in bathtub using one pump that delivers pressurized water to a valve having a lower housing for directing the flow of water and an upper housing containing an electric motor for actuating the valve mechanism. The upper housing is water-tight and removable from the lower housing. The valve is directly coupled to the water pump through gears to provide precise positioning of the valve.

### CROSS REFERENCE TO RELATED APPLICATION

This application claims benefit of U.S. Provisional Patent Application Ser. No. 63/822,589, filed Jun. 12, 2025 and Ser. No. 63/747,327, filed Jan. 20, 2025, and each is incorporated herein by reference in its entirety.

### TECHNICAL FIELD

The present invention relates to valves for use in water distribution systems. More particularly, the present invention relates to an improved valve with a water-tight motor cap removably mounted to enable readily accessing an electric actuator motor for replacement for use of the valve in a reconfigurable water distribution system for selective communicating of pressurized water through a first outlet or a second outlet for selected different water use functions.

### BACKGROUND

Walk-in bathtubs provide easier ingress and egress through a water-tight, hinged door, and provide a seat for the bather. In walk-in bathtubs, there are multiple types of therapies and functions which can be provided, such as a whirlpool system with bath jets, a micro nano bubbles system with small jets, an air system, lights, heating pads, and a rapid water discharge system.

Walk-in bathtubs offering the whirlpool, micro nano bubbles, and rapid water discharge systems may each require a separate pump. This is a two-fold problem as the pumps are expensive and there is very limited real estate underneath the bathtub to fit the components, plumbing and the electronics to operate the tub. The available space is generally confined to a compartment below the seat. Developments, however, have been made to provide water distribution system systems offering single pump, multiple bathing function capability. Such systems use motor-actuated valves operated by a function controller. The motors however periodically require replacement. The crowded equipment bay, even with a reduced number of pumps, makes motor servicing and replacement difficult. Accordingly, there is a need in the art for an improved valve for a single pump/multiple functions water distribution systems for walk-in bathtubs. It is to such that the present invention is directed.

### BRIEF SUMMARY OF THE INVENTION

The present invention meets a need in the walk-in bathtub art by providing a reconfigurable water distribution system for a walk-in bathtub, comprising:
a motorized pump having an inlet connected to a suction port of a water reservoir of a walk-in bathtub and an outlet for delivering pressurized water during operation of the pump;
a valve housing having a water-tight lower portion and a water-tight motor cap removably mounted to the lower portion, the lower portion having an inlet for receiving pressurized water from the pump, a first outlet for communicating pressurized water to a first piping system and a second outlet for communicating pressurized water to a second piping system, the motor cap defining a motor cavity housing an electric motor having a motor gear, a valve being selectively movable to a first position for communicating pressurized water through the first outlet for a first bathing function, the valve being selectively movable to a second position for communicating pressurized water through the second outlet for a second bathing function, and the valve having valve gear configured to mesh with the motor gear for rotational actuation of the valve gear through actuation of the motor gear, the valve gear being positioned within the cavity of the motor cap, and
a controller connected to the valve for moving the valve through actuation of the electric motor to the first position for communicating pressurized water to the first piping system and to the second position for communicating pressurized water to the second piping system,
whereby the electric motor is readily accessible for replacement for the reconfigurable water distribution system that selectively provides multiple operational functions independently with one pump.

In another aspect, the present invention provides a reconfigurable water distribution system for a walk-in bathtub, comprising:
a motorized pump having a motor housing, an inlet connected to a suction port of a water reservoir of a walk-in bathtub and an outlet for delivering pressurized water during operation of the pump;
a valve coupled directly to the motorized pump, the valve having a housing with a valve housing inlet directly coupled to the pump outlet for receiving pressurized water directly from the pump, said valve being selectively positioned at least in a first position directing water to a valve housing first outlet and a second position directing water to a valve housing second outlet, said valve housing having a lower portion having a plurality of first alignment tabs and a motor cap having a plurality of second alignment tabs configured to align with the plurality of first alignment tabs, each said second alignment tab having a pivotal catch configured to engage one first alignment tab of the plurality of first alignment tabs, and
a controller connected to the valve for movement between the first position and the second position for communicating pressurized water selectively to one of the outlet ports of the first position and the second position,
whereby the reconfigurable water distribution system selectively provides a plurality of operational bathtub functions independently with one pump.

In another aspect, the present invention provides for coupling the valve directly to the pump to reduce the volume necessary to house these components. Also, the valve motor is housed in a watertight housing separate from the remaining portions of the valve to simplify the repairing of the valve.

In another aspect, the present invention meets a need in the art by providing a valve for a reconfigurable water distribution system, comprising a valve housing having a water-tight lower portion and a water-tight motor cap removably mounted to the lower portion, the lower portion having an inlet for receiving pressurized water from a pump, a first outlet for communicating pressurized water to a first piping system and a second outlet for communicating pressurized water to a second piping system, the motor cap defining a motor cavity housing an electric motor having a motor gear, the valve being selectively movable to a first position for communicating pressurized water through the first outlet for a water use function, the valve being selectively movable to a second position for communicating pressurized water through the second outlet for a second water use function, and the valve having a valve gear configured to mesh with the motor gear for rotational actuation of the valve gear through actuation of motor gear, the valve gear being positioned within the cavity of the motor cap, whereby the electric motor is readily accessible for replacement for use in a reconfigurable water distribution system that selectively provides multiple operational functions independently with one pump.

In yet another aspect, the present invention provides A valve for a reconfigurable water distribution system, comprising a valve housing having a valve inlet for coupling to a pump outlet for receiving pressurized water from the pump, said valve being selectively positioned at least in a first position directing water to a valve housing first outlet for communicating pressurized water to a first piping system and a second position directing water to a valve housing second outlet for communicating pressurized water to a second piping system, said valve housing having a lower portion having a plurality of first alignment tabs and a motor cap enclosing an electric motor, said motor cap having a plurality of second alignment tabs configured to align with the plurality of first alignment tabs, each said second alignment tab having a pivotal catch configured to engage one first alignment tab of the plurality of first alignment tabs, whereby the electric motor for use in a reconfigurable water distribution system that selectively provides multiple operational functions independently with one pump is readily accessible for replacement by operation of the pivotal catch.

Objects, advantages, and features of the present invention according to the present disclosure will readily be appreciated by persons skilled in the art upon a reading of the following detailed description in conjunction with the drawings.

### BRIEF DESCRIPTION OF THE DRAWINGS

FIG. 1 illustrates in a partially broken-away, diagrammatic isometric view an exemplary embodiment of a walk-in tub installation.

FIG. 2 illustrates in a diagrammatic end view the tub installation of FIG. 1.

FIG. 3 illustrates in a partially broken-away, diagrammatic side view the tub installation of FIG. 1.

FIG. 4 illustrates in a simplified schematic diagram an exemplary embodiment of a water distribution system employing a single pump to operate three functions in a walk-in bathtub installation.

FIG. 5 illustrates a perspective view of an exemplary embodiment of a water valve of a water distribution system of the present invention.

FIG. 6 illustrates a partially exploded perspective view of another exemplary embodiment of a water valve of a water distribution system of the present invention.

FIG. 7 is a side view of the water valve of FIG. 6.

FIG. 8 is a top perspective view of the water valve of FIG. 6 shown with a cap portion inverted for clarity.

### DETAILED DESCRIPTION

In the following detailed description and in the several figures of the drawings, like elements are identified with like reference numerals. The figures are not to scale, and relative feature sizes may be exaggerated for illustrative purposes. Further, the detailed description initially describes a water distribution system featuring single pump/multiple bathing functions with a valve according to the present invention, which water distribution system provides for coupling the valve directly to the pump to reduce the volume necessary to house these components. The detailed description further describes the structure of an illustrative embodiment of the value in which a valve motor is housed in a watertight housing separate from the remaining portions of the valve to simplify the repairing of the valve.

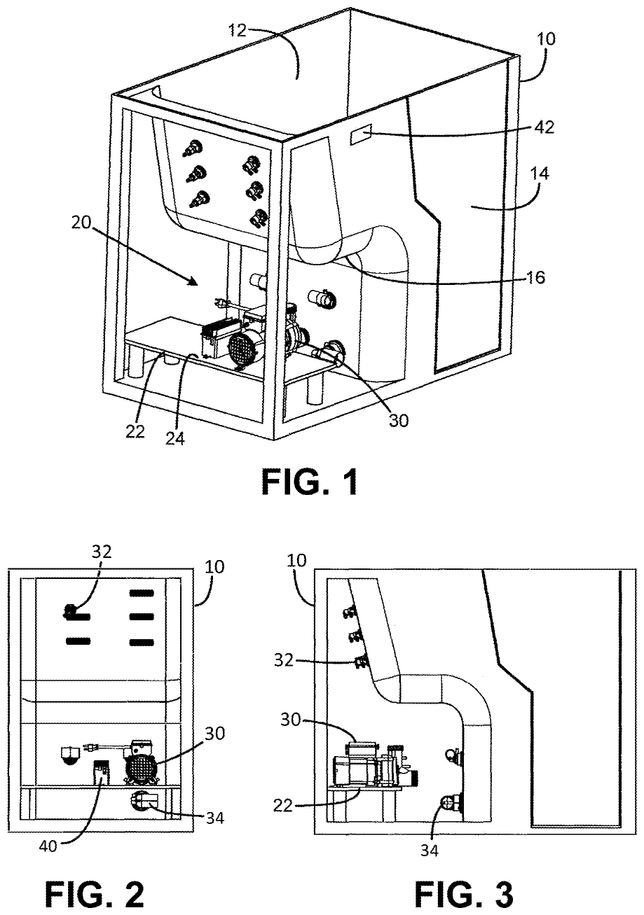

FIGS. 1-3 illustrate a walk-in tub installation generally 9 and a water distribution system generally 120 featuring selective bathing operations with a single pump 30 coupled to a selective distribution 4-way valve 64-12. The installation includes a tub structure 10 which includes a water reservoir 12 defined by the tub structure, and a door 14 which swings on hinges between a water-tight closed position and an open position, which door allows the user ready egress into and from the water reservoir. Typically, the tub structure 10 defines a seat platform 16 for the user bather to sit while bathing with the door closed, and water filling the reservoir 12 to a comfortable level for the user. Manual valve elements and plumbing pipes and connections to water supply lines (not shown in FIGS. 1-3) allow the user to control the filling of the bathing water into the tub reservoir 12.

The tub structure 10 defines an open space 20 under and behind the seat 16, into which the tub installation pump 30, valve 64-12, operational controls, and water distribution pipes are installed. This space can be quite limited in volume, with the installation equipment mounted to a platform 22. The equipment includes the motor driven pump 30 and an electronic controller unit 24. A user interface control panel 42 is positioned for ready access by the user, to control operation of the tub functions selectively.

The tub installation 9 includes an array or network of water jets 32, through which water is pumped by the pump 30 under pressure to provide a therapeutic effect for the user bather. A recirculating water flow path is provided (interconnecting pipes not illustrated in FIGS. 1-3), with the pump 30 drawing bathing water from the reservoir 12 through a suction fitting 34, and the pump directing pressurized water through the valve 64-12 to the water jets 32. This is a first water use function provided by the installation.

Another water use function which may be implemented selectively in the exemplary embodiment is a rapid water discharge function, activated by the user once finished bathing, to actively pump water out from the reservoir 12 into the sanitary drain, to speed up the tub drain process so that the user when finished bathing, may open the door 14 without water escaping through the door opening. This function may be implemented by use of the pump 30 as well, without requiring a separate pump dedicated to the rapid water discharge function.

Another water use function which may be implemented in an exemplary embodiment is a micro-nano bubble (MNB) function, in which water and entrained air is forced through a small jet or a network of small jets, typically known as MNB jets 36, positioned in the tub walls. This function delivers air-entrained water to the small jets, creating a milk-water effect. This MNB function may be implemented selectively in the exemplary embodiment without requiring a separate pump dedicated to this function. In this embodiment, air is entrained in the water at the pump or at a distribution port in a side wall of the reservoir 12.

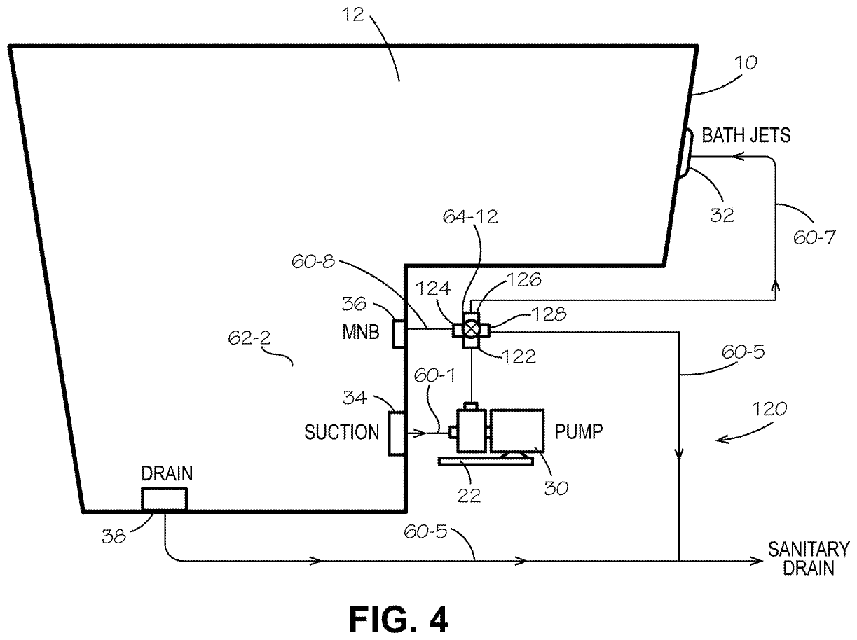

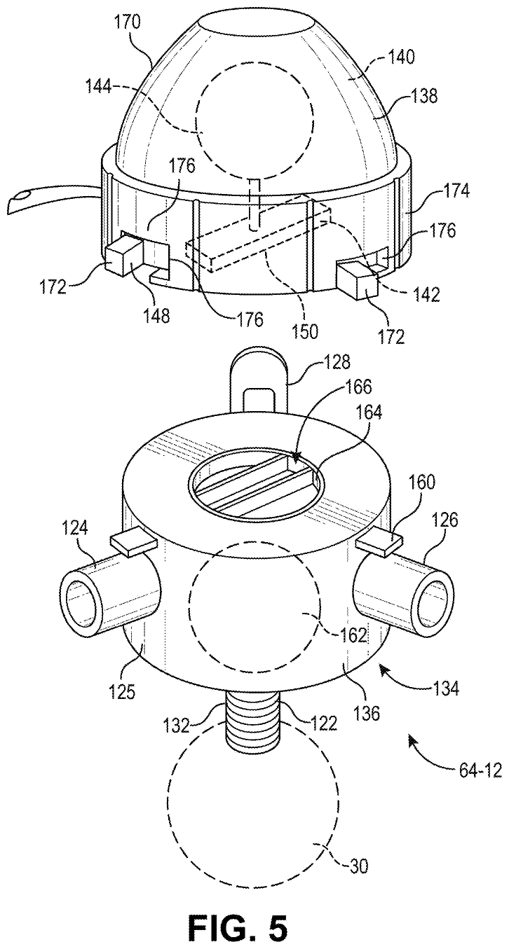

In accordance with aspects of the invention, the two or more bathing functions can be realized in a bathing tub installation, such as the illustrated walk-in tub, with a reconfigurable water distribution system 120 including the pipe network, a single pump 30, the valve 64-12 selectively positionable in two or more distribution positions, typically motorized and controlled by the controller 24, in accordance with user commands entered on the control panel 42 mounted on the tub structure. The valve 64-12 is selectively operated in response to control signals from the controller 24. An illustrative embodiment is described below, with respect to FIG. 4 while FIG. 5 illustrates an embodiment of a 4-way valve for use in the single pump/multiple bathing function tub installation.

FIG. 4 illustrates in schematic form a walk-in tub installation 9 employing a reconfigurable water distribution system 120 which provides three bathing functions, namely, a water jet function, an MNB function, and a rapid water discharge, with the single pump 30. In this embodiment, the functions may be performed selectively one at a time, with the bathing function selected by the setting of the valve 64-12 in response to signals from the controller 24 as selected by the bather using the interface control panel 42. The tub system with the reconfigurable water distribution system 120 is configured with a bottom-entry single “L” 4-way valve 64-12 to operate the three bathtub bathing functions with the single pump 30. The valve 64-12 has an inlet port 122 and three selectable outlet ports 124, 126, and 128. The pump 30 provides pressurized water to the inlet port 122 of the valve 64-12. The outlet ports of the valve 64-12 provide the three bathing functions selectively independently operative for communicating water (a) through outlet port 124 to provide an MNB micro-nano bubble bathing function in the bath water held in the water reservoir 12 through pipe section 60-8 and the MNB jets 36, (b) though outlet port 126 and a pipe section 60-7 for pressurized water flow bathing function into the water reservoir 12 through the bath jets 32, and (c) though outlet port 128 and the pipe section 60-5 for a rapid water discharge or drain function mode, using the single pump 30 and the valve 64-12.

The pipe network in this embodiment includes several piping sections. Pipe section 60-1 connects between the suction fitting 34 in a tub wall and the suction port of the pump 30, and allows water to be drawn from the reservoir 12 for pumping from the suction port of the pump 30. The pipe section 60-8 connects between the outlet port 124 of the valve 64-12 and the MNB jets 36. If there is a single MNB jet, the section 60-8 will be connected directly to the MNB jet; if there is a plurality of MNB jets, section 60-8 can be a pipe manifold with a separate pipe for each MNB jet.

The system 120 further includes the pipe section 60-7 connected between the outlet port 126 and the bath jets 32, directly or for a plurality of jets 32 through a manifold that distributes pressurized water to each of the plurality of jets arranged as an array in a wall of the tub.

A pipe section 60-5 connects between the outlet port 128 of the valve 64-12 and a drain 38 for the tub. Typically, the drain connection will be to an overflow connection for the tub, so that water can be discharged whether the tub drain stopper is in place or not, for example, as described in U.S. Pat. No. 8,549,678, for an accelerated tub drain for a walk-in tub installation.

The reconfigurable system 120 is configured to provide the three bathing functions of the MNB jet function, the water jet function, and the fast water discharge function, selectively with the single pump 30. For the MNB function, the valve 64-12 is set to the open position to communicate pressured water to the pipe section 60-8. With the pump 30 operating, the pump discharge is sent through the valve 64-12 and pipe section 60-8 to the MNB jets 36 and no water is sent to the jets 32 or to the drain 38. For the jet function, the valve 64-12 is set open to the pipe section 60-7 for communicating pump discharge to the jets 32 while the pump 30 is operating. For the fast water discharge function, the valve 64-12 is open to the pipe section 60-5, for sending the pressurized water from the pump 30 to the sanitary drain for the drain 38 while the pump is operating.

The pipe sections may be rigid pipe sections, flexible pipe sections or a combination of rigid and flexible. The valve 64-12 is operatively connected to the controller 24, which supplies control signals to the valve based on bather selection of the bathing function to be performed using the interface control panel 42.

The water flows from the pump 30 into the valve 64-12 through the inlet 122 and out through one of the three outlet ports 124, 126, or 128. The pipe section 60-1 connects between the suction fitting 34 in the tub wall to the suction port of the pump 30, and allows water to be drawn from the water reservoir 12 for pumping from the suction port through the pump. The outlet port 124 connects with the pipe section 60-8 to the MNB microbubbles generator 36. The outlet port 126 connects to the pipe 60-7 to the bath jets 32. The outlet port 128 connects with the pipe section 60-5 to the sanitary drain. The floor drain 38 of the reservoir 12 also connects to the sanitary drain (such as to the pipe section 60-5). The electronic controller 24 connects to the interface control panel 42 and the motorized controller for the valve 64-12 for selective operation of the three bathing functions or operating modes for MNB treatment, pressurized jets, or rapid water discharge in preparation for the bather to exit the bathtub 10.

With reference to FIG. 4, the electronic controller 24 operates the valve 64-12. In the illustrated embodiment, the valve 64-12 is biased to a first position for directing water from the outlet 126 to the bath jets 32. The valve 64-12 however selectively operates for MNB microbubbles bathing function or for quick draining bathing function for bather egress. The interface control panel 42 may display the operative status or position of the valve 64-12.

Upon filling of the water reservoir 12, the water distribution system 120 illustrated in FIG. 4 operates to provide independently the MNB micro-nano bubble bathing function, the pressurized jets bathing function, and the rapid water discharge draining bathing function, selectively. The water distribution system 120 in an illustrative implementation biases the valve 64-12 for directing pressurized water from the pump 30 through the pipe section 60-7 to the bath jets 32. This allows filling of the bathtub for bathing use. The interface control panel 42 may be operated to select MNB jet 34 bathing function or pressurized jet 32 bathing function. Upon selection of the MNB jet function, the pump 30 if operating stops. The valve 64-12 moves to direct water flow to the outlet 124 for communication pressurized water through the connector pipe 60-8 to the MNB jets 36 and into the bath water of the reservoir. The pump 30 then starts and micro-nano bubbles flow through the MNB jet 36 into the bath water.

Upon selection of the pressurized jet function, the pump 30 if operating stops. The valve 64-12 moves to direct water flow to the outlet 126 for communication of pressurized water through the connector pipe 60-7 to the bath jets 32 and into the bath water of the reservoir. The pump 30 starts and the pressurized water jets into the bath water. The bather may alternate the selection of the independent MNB jet or pressurized jet water flow for bathing functions.

To exit the bathtub, the bather selectively operates a fast drain switch on the interface control panel 42. In the illustrative embodiment, the switch is held for a predetermined period such as 3 seconds. The interface control panel 42 then prepares for raid drain bathing function of the bath water for bather egress. The pump 30 if operating stops. The valve 64-12 operates to move to the quick drain position for outlet 128. The floor drain 38 is opened. The pump 30 then starts and pressurized water flows from the pump into the valve 64-12 and out of the outlet port 128 to the drain pipe 60-5 and to the sanitary drain. The pump 30 operates for a predetermined period to drain water from the water reservoir. Preferably the pump operates for a period sufficient to lower the water level below a threshold of the door to the water reservoir. This allows bather egress through the door of the walk-in bathtub without spillage for water from the reservoir 12. The pump 30 stops. Residual water drains through the floor drain 38 to the sanitary drain. The interface control panel 42 then operates to move the valve 64-12 to the position for communicating through the outlet port 126 for the bath jets 32. The floor drain 38 is closed. The bathtub 10 is then ready for a subsequent filling of the water reservoir 12 and bathing.

With reference next to FIG. 5, there is shown an illustrative embodiment of a 4-way valve 64-12. Here, the valve 64-12 has the inlet port 122 that has external threads 132 so that the inlet port 122 may be threadably mounted threaded directly into an internally threaded outlet port of the pump 30, thus eliminating the need for section of pipe connecting the valve to the pump. With the pump 30 coupled directly to the valve 64-12, the water passes into the valve 64-12 in a more efficient manner. The term “directly”, “directly to”, and “coupled directly” means that the structure of the valve 64-12 is mounted directly to the structure of the pump without any intervening water pipes, lines or conduits extending between the pump and the valve, i.e., a valve inlet is mounted to the pump outlet without additional pipes therebetween. The elimination of additional pipes allows for better flow of water from one component to another, while also minimizing the size of the water circulating components and maximizing the room within the bathtub structure to work within the confines of the bathtub structure while making repairs.

The valve 64-12 includes a housing 134 having a lower portion 136 and a removable, water-tight upper portion, bell housing or cap 138 that defines a cavity 140 in which is positioned the valve actuator 142 and the electric motor 144 and a portion of the valve actuator 142 coupled to the electric motor 144 for imparting movement of the valving components, as previously described. The valve actuator 142 has an engagement bar 150 positioned outside the confines of the bell housing 138. The bell housing 138 is removable to allow for the quick changing access to the electric motor 144, so that the electric motor 144 may be easily replaced without having to disassemble the entire valve 64-12 from the water piping systems.

The lower portion 136 again is shown to have a cylindrical sidewall 125 from which extends three outlets 124, 126 and 128 in addition to the inlet port 122; as such, the illustrative embodiment is a 4-port valve; however, it should be understood that there may be any limited number of such outlets. The lower portion 135 is water-tight, except for the inlet and outlet ports, to minimize the threat of leaking. The inlet port 122 is threaded so that it may be coupled directly to the pump 30 without any intervening conduits or tubes to minimize the volume required to house the valve 64-12 within the structure of the bathtub. The lower portion 136 also has three alignment tabs 160 extending radially from the cylindrical sidewall 125.

The lower portion 136 also has a conventional interior ball 162 having a channel therethrough that direct the flow of water from the water inlet port 122 to the desired outlet tubes 124, 126, and 128. The interior ball 162 has a top axle or stem that is coupled to a circular catch 164 having a rectangular key or recess 166 configured to receive in register the engagement bar 150 of the valve actuator 142.

The bell housing 138 is generally dome-shaped to form the interior cavity 140. The bell housing 138 has an exterior wall 170 having three radially extending alignment tabs 172. The bell housing 138 includes a rotatable locking ring 174 that is rotatable relative to the exterior wall 170. The locking ring 174 has three inverted L-shaped locking slots 176 that are configured to capture the alignment tabs 160 of the lower portion 136 when the locking ring 174 is rotated from its unlocked position to its locked position fixing the bell housing 138 to the lower portion 136.

Thus, the bell housing 138 may be easily coupled to the lower portion 136 by registering the engagement bar 150 into the rectangular recess 66 of the circular catch 164 of the lower portion 136. The locking ring 174 is then rotated from its unlocked position to its locked position to couple the bell housing 138 to the lower portion 136. A broken or malfunctioning electric motor 144 may be replaced by simply moving the locking ring to its unlocked position and removing the bell housing 138 encapsulating the electric motor 144 from the lower portion 136. This is a vast improvement over the prior art that required the replacement of the entire valve to replace a defective motor.

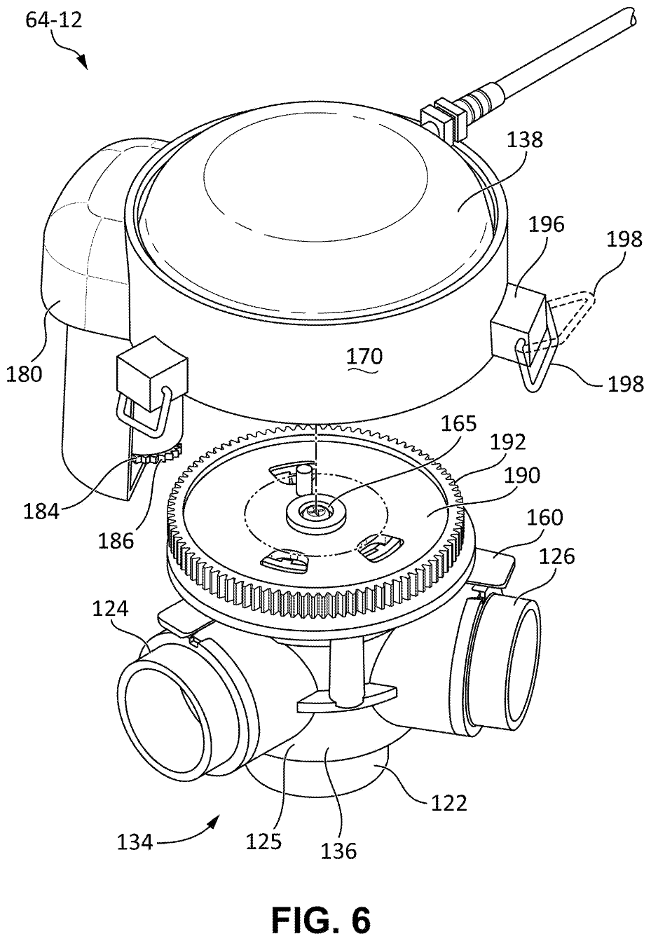

With reference next to FIGS. 6-8, there is shown an alternative embodiment of a 3 way valve 64-12. Here, the valve 64-12 has an inlet port 122 that can be mounted directly to the outlet port of the pump 30, thus eliminating the need for pipe section 62-2, the inlet port 122 and outlet port of the pump may include threading to aid in the mounting of the components. With the pump 30 coupled directly to the valve 64-12, the water passes into the valve 64-12 in a more efficient manner. The term “directly”, “directly to”, and “coupled directly” means that the structure of the valve 64-12 is mounted directly to the structure of the pump without any intervening water pipes, lines or conduits extending between the pump and the valve, i.e., a valve inlet port is mounted to the pump outlet without additional pipes therebetween. The elimination of additional pipes allows for better flow of water from one component to another, while also minimizing the size of the water circulating components and maximizing the room within the bathtub structure to work within the confines of the bathtub structure while making repairs.

The valve 64-12 includes a housing 134 having a lower portion 136 and a removable, water-tight upper portion, bell housing or cap 138 that defines a cavity 140. The cap 138 also includes a motor housing or motor housing portion 180 encasing a peripherally positioned electric motor 182 with a circular motor gear 184 having external gear teeth 186 for imparting movement of the valving components, as previously described. The bell housing 138 is removable to allow for the quick changing access to the electric motor 182, so that the electric motor 182 may be easily replaced without having to disassemble the entire valve 64-12 from the water piping systems.

The lower portion 136 again is shown to have a cylindrical sidewall 125 from which extends three outlets 124, 126 and 128 in addition to the inlet port 122; as such, the illustrative embodiment is a 4 port valve; however, it should be understood that there may be any limited number of such outlets. The lower portion 136 is water-tight, except for the inlet and outlet ports, to minimize the threat of leaking. The inlet port 122 may be threaded so that it may be coupled directly to the pump 30 without any intervening conduits or tubes to minimize the volume required to house the valve 64-12 within the structure of the bathtub. The lower portion 136 also has three alignment tabs 160 extending radially from the cylindrical sidewall 125.

The lower portion 136 also has a conventional interior ball 162, similar to that shown in FIG. 5, having a channel 163 therethrough that directs the flow of water from the water inlet port 122 to the desired outlet tubes 124, 126, and 128. The interior ball 162 has a top axle or stem 165 that is coupled to a top gear 190, positioned on the exterior of the lower portion 135. The top gear 190 has peripheral gear teeth 192 configured to mesh with the gear teeth 186 of the motor gear 184 of electric motor 182.

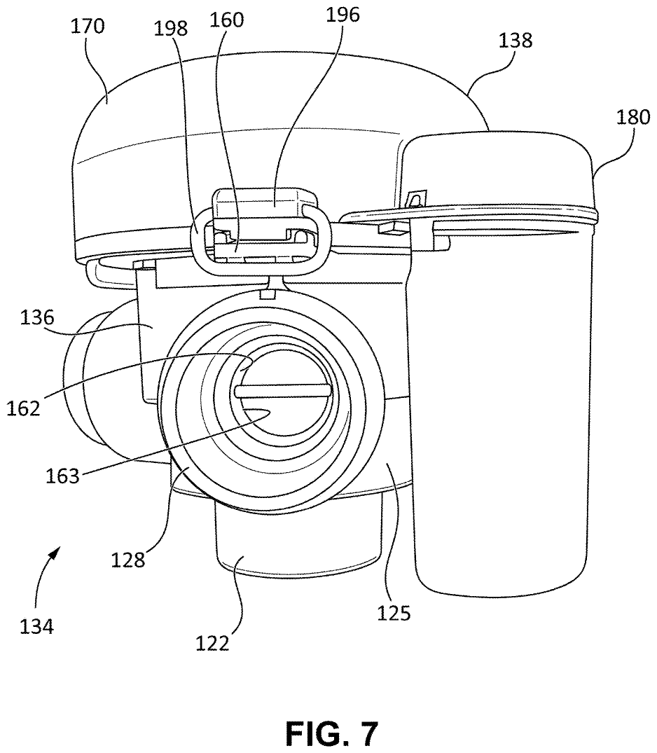

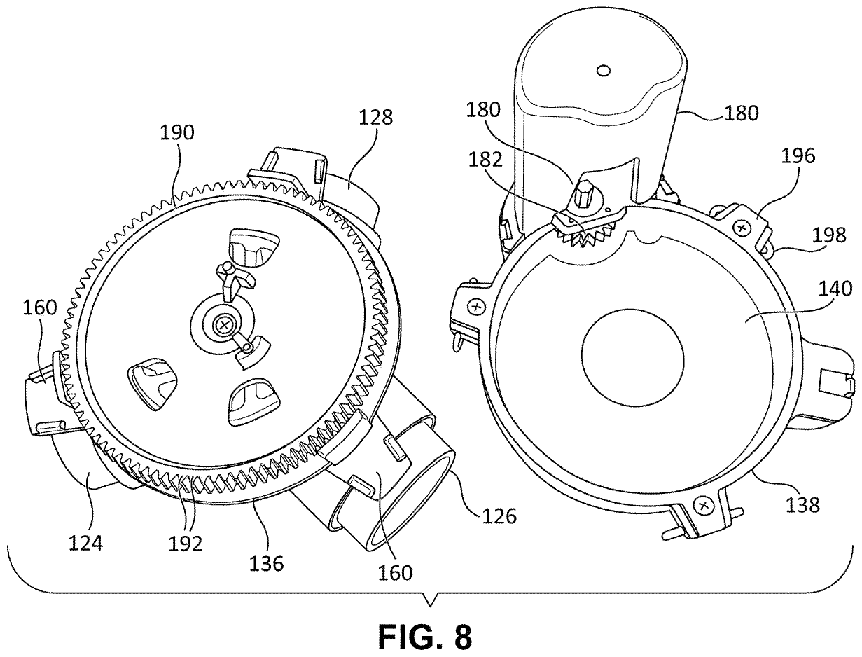

The bell housing 138 is generally dome-shaped to form the interior cavity 140. The bell housing 138 has an exterior wall 170 having three radially extending alignment tabs or bosses 196. Each alignment tab 196 has a pivotal or rotatable generally rectangular wire locking catch or ring 198 that is configured to capture and snugly hold the alignment tabs 160 of the lower portion 136 when the locking catch 198 is pivoted from its unlocked position, shown in phantom lines in FIG. 7, to its locked position, shown in solid lines in FIG. 8, thereby fixing the position of the bell housing 138 to the lower portion 136. A rubber O-ring may be positioned between the side wall 125 of the cap 138 and the lower portion 36 to ensure a water-tight seal therebetween.

Thus, the bell housing 138 may be easily coupled to the lower portion 136 by registering the teeth 186 of the motor gear 184 with the teeth 192 of the top gear 190 and aligning the alignment tabs 196 of the bell housing 138 with the alignment tabs 160 of the lower portion 136. The locking catches 198 are then pivoted from their unlocked position to its locked position to couple the bell housing 138 to the lower portion 136. A broken or malfunctioning electric motor 182 may be replaced by simply moving the locking catches 198 to their unlocked position and removing the bell housing 138 including the electric motor 182 from the lower portion 136. This is a vast improvement over the prior art that required the replacement of the entire valve to replace a defective motor.

Additionally, the use of peripheral gears allows for a more precise positioning of the ball valve during operation.

Although the foregoing has been a description and illustration of specific embodiments of the subject matter, various modifications and changes thereto can be made by persons skilled in the art without departing from the scope and spirit of the invention.

What is claimed is:

1. A reconfigurable water distribution system for a walk-in bathtub, comprising:
a motorized pump having an inlet connected to a suction port of a water reservoir of a walk-in bathtub and an outlet for delivering pressurized water during operation of the pump;
a valve housing having a water-tight lower portion and a water-tight motor cap removably mounted to the lower portion, the lower portion having an inlet for receiving pressurized water from the pump, a first outlet for communicating pressurized water to a first piping system and a second outlet for communicating pressurized water to a second piping system, the motor cap defining a motor cavity housing an electric motor having a motor gear, a valve being selectively movable to a first position for communicating pressurized water through the first outlet for a first bathing function, the valve being selectively movable to a second position for communicating pressurized water through the second outlet for a second bathing function, and the valve having valve gear configured to mesh with the motor gear for rotational actuation of the valve gear through actuation of the motor gear, and
a controller connected to the valve for moving the valve through actuation of the electric motor to the first position for communicating pressurized water to the first piping system and to the second position for communicating pressurized water to the second piping system,
whereby the electric motor is readily accessible for replacement for the reconfigurable water distribution system that selectively provides multiple operational functions independently with one pump.

2. The reconfigurable water distribution system as recited in claim 1, wherein the valve has a third outlet for communicating pressurized water to a third piping system for a third bathing function; and
the controller for moving to a third position for communicating pressurized water to the second piping system.

3. The reconfigurable water distribution system as recited in claim 1, wherein the first piping system connects to a discharge port in the walk-in bathtub configured for generating micro bubbles that flow in the water reservoir of the walk-in bathtub.

4. The reconfigurable water distribution system as recited in claim 1, wherein the first piping system connects to one or more bath jets in the walk-in bathtub for discharging one or more jets of pressurized water into the water reservoir of the walk-in bathtub.

5. The reconfigurable water distribution system as recited in claim 1, wherein the first piping system connects a drain for selective rapid draining function of the water reservoir.

6. The reconfigurable water distribution system as recited in claim 1, wherein the first piping system connects to a discharge port in the walk-in bathtub configured for generating micro bubbles that flow into the water reservoir of the walk-in bathtub for the first bathing function; and
the second piping system connects to one or more bath jets in the walk-in bathtub for discharging one or more jets of pressurized water into the water reservoir of the walk-in bathtub for the second bathing function.

7. The reconfigurable water distribution system as recited in claim 1, wherein the lower portion has a plurality of alignment tabs, and wherein the motor cap has a plurality of alignment tabs configured to be coupled with the plurality of alignment tabs of the lower portion.

8. The reconfigurable water distribution system as recited in claim 7, wherein the plurality of alignment tabs of the motor cap includes a pivotal catch configured to capture the alignment tabs of the lower portion.

9. The reconfigurable water distribution system as recited in claim 1, wherein the valve is three-port valve.

10. The reconfigurable water distribution system as recited in claim 1, wherein the valve gear has peripheral gear teeth and wherein the motor gear meshes with the peripheral gear teeth of the valve gear.

11. The reconfigurable water distribution system of claim 1, wherein the valve gear is positioned within the cavity of the motor cap.

12. A reconfigurable water distribution system for a walk-in bathtub, comprising:
a motorized pump having a motor housing, an inlet connected to a suction port of a water reservoir of a walk-in bathtub and an outlet for delivering pressurized water during operation of the pump;
a valve coupled directly to the motorized pump, the valve having a housing with a valve housing inlet directly coupled to the pump outlet for receiving pressurized water directly from the pump, said valve being selectively positioned at least in a first position directing water to a valve housing first outlet and a second position directing water to a valve housing second outlet, said valve housing having a lower portion having a plurality of first alignment tabs and a motor cap having a plurality of second alignment tabs configured to align with the plurality of first alignment tabs, each said second alignment tab having a pivotal catch configured to engage one first alignment tab of the plurality of first alignment tabs, and
a controller connected to the valve for movement between the first position and the second position for communicating pressurized water selectively to one of the outlet ports of the first position and the second position,
whereby the reconfigurable water distribution system selectively provides a plurality of operational bathtub functions independently with one pump.

13. The reconfigurable water distribution system as recited in claim 12, wherein the first outlet port connects to a port in the walk-in bathtub configured for generating micro bubbles that flow with the pressurized water into the reservoir of the walk-in bathtub.

14. The reconfigurable water distribution system as recited in claim 12, wherein the first outlet port connects to one or more bath jets in the walk-in bathtub for discharging one or more jets of pressurized water into the reservoir of the walk-in bathtub.

15. The reconfigurable water distribution system as recited in claim 12, wherein the first outlet port connects to a drain for quick draining of the pressurized water from the reservoir of the walk-in bathtub.

16. The reconfigurable water distribution system as recited in claim 12, wherein the valve comprises three outlet ports, a first outlet port connects to a discharge port in the walk-in bathtub configured for generating micro bubbles that flow into the water reservoir of the walk-in bathtub for a first bathtub function, a second outlet port connects to one or more bath jets in the walk-in bathtub for discharging one or more jets of pressurized water into the water reservoir of the walk-in bathtub for a second bathtub function, and a third outlet port connects to a sanitary drain for a draining bathtub function.

17. The reconfigurable water distribution system as recited in claim 12, wherein the valve is motorized for operational control by the controller.

18. The reconfigurable water distribution system as recited in claim 12, wherein each said catch is configured to be pivoted to capture each alignment tab of the lower housing within the catch.

19. The reconfigurable water distribution system as recited in claim 12, wherein the valve has an electric motor having a motor gear positioned within the motor cap, and wherein the valve includes an interior ball valve and a valve gear coupled to the interior ball valve, the motor gear being configured to mesh with the valve gear of the ball valve for actuation of the ball valve through actuation of the electric motor.

20. The reconfigurable water distribution system as recited in claim 19, wherein the valve gear has peripheral gear teeth and wherein the motor gear meshes with the peripheral gear teeth of the valve gear.

21. A valve for a reconfigurable water distribution system, comprising:
a valve housing having a water-tight lower portion and a water-tight motor cap removably mounted to the lower portion, the lower portion having an inlet for receiving pressurized water from a pump, a first outlet for communicating pressurized water to a first piping system, and a second outlet for communicating pressurized water to a second piping system;
the motor cap defining a motor cavity housing an electric motor having a motor gear;
a valve gear configured to mesh with the motor gear for rotational actuation of the valve gear through actuation of motor gear, the valve gear being positioned within the cavity of the motor cap;
the valve being selectively movable to a first position for communicating pressurized water through the first outlet for a first water use function, the valve being selectively movable to a second position for communicating pressurized water through the second outlet for a second water use function,
whereby the electric motor is readily accessible for replacement for use in a reconfigurable water distribution system that selectively provides multiple operational functions independently with one pump.

22. The valve as recited in claim 21, wherein the lower portion of the valve housing having a plurality of first alignment tabs and the motor cap having a plurality of second alignment tabs configured to couple with the plurality of first alignment tabs, whereby the lower portion and the motor cap interconnect together.

23. The valve as recited in claim 22, wherein each said second alignment tab having a pivotal catch configured to engage one first alignment tab of the plurality of the first alignment tabs.

24. The valve as recited in claim 21, wherein the valve housing has a third outlet for communicating pressurized water to a third piping system, said first piping system for connecting to a discharge port in a walk-in bathtub configured for generating micro bubbles for flowing into a water reservoir of the walk-in bathtub, said second piping system for connecting to one or more bath jets in the walk-in bathtub, and said third piping system for connecting to a sanitary drain.

25. The valve as recited in claim 21, further comprising a controller for operation of the motorized valve for selective positioning for the first water use function or the second water use function.

26. A valve for a reconfigurable water distribution system, comprising:
a valve housing having a valve inlet for coupling to a pump outlet for receiving pressurized water from the pump, said valve being selectively positioned at least in a first position directing water to a valve housing first outlet for communicating pressurized water to a first piping system and a second position directing water to a valve housing second outlet for communicating pressurized water to a second piping system, said valve housing having a lower portion having a plurality of first alignment tabs and a motor cap enclosing an electric motor, said motor cap having a plurality of second alignment tabs configured to align with the plurality of first alignment tabs, each said second alignment tab having a pivotal catch configured to engage one first alignment tab of the plurality of first alignment tabs, and
whereby the electric motor for use in a reconfigurable water distribution system that selectively provides multiple operational functions independently with one pump is readily accessible for replacement by operation of the pivotal catch.
